(19) United States
(12) Patent Application Publication
(10) Pub. No.: US 2011/0176616 A1
(43) Pub. Date: Jul. 21, 2011

(54) FULL RESOLUTION 3D VIDEO WITH 2D BACKWARD COMPATIBLE SIGNAL

(75) Inventors: Ajay K. Luthra, San Diego, CA (US); Paul Moroney, La Jolla, CA (US)

(73) Assignee: GENERAL INSTRUMENT CORPORATION, Horsham, PA (US)

(21) Appl. No.: 13/011,523

(22) Filed: Jan. 21, 2011

Related U.S. Application Data
(60) Provisional application No. 61/297,134, filed on Jan. 21, 2010.

(51) Int. Cl. H04N 7/12

(52) U.S. Cl. 375/240.16; 375/E07.104; 375/E07.105; 375/E07.115; 375/E07.243

(57) ABSTRACT

Items are used to encode or in encoding a stereoscopic video signal. The signal includes first view frames based on a first view associated with a first eye perspective and second view frames based on a second view associated with a second eye perspective. The encoding includes receiving the stereoscopic video signal and determining the first view frames and the second view frames. The encoding also includes encoding the first view frames based on the first view and encoding the second view frames based on the second view and also the first view. In the encoding, a plurality of the encoded second view frames reference at least one first view frame for predictive coding information. Items are also used to decode the encoded stereoscopic video signal.

### CLAIM FOR PRIORITY

The present application claims the benefit of priority to U.S. Provisional Patent Application Ser. No. 61/297,134, filed on Jan. 21, 2010, entitled “1080p60 2DTV Compatible 3DTV System”, by Ajay K. Luthra, et al., the disclosure of which is hereby incorporated by reference in its entirety.

### BACKGROUND

Depth perception for three dimensional (3D) video, also called stereoscopic video, is often provided through video compression by capturing two related but different views, one for the left eye and another for the right eye. The two views are compressed in an encoding process and sent over various networks or stored on storage media. A decoder for compressed 3D video decodes the two views and then sends the decoded 3D video for presentation. A variety of formats are used to encode, decode and present the two views. The various formats are utilized for different reasons and may be placed into two broad categories. In one category, the two views for each eye are kept separate with a full resolution of both views transmitted and presented for viewing.

In the second category, the two views are merged together into a single video frame. Merging is sometimes done using a checker board pattern to merge checkered representations from the two separate views. Another way of merging is by using panels taken from the two separate views, either left and right or top and bottom. The panels are then merged into a single video frame.

By merging the two views, a transmission of the compressed 3D video utilizes less resources and may be transmitted at a lower bit rate and/or by using less bandwidth than if the two views were kept separate for encoding, transmission and presentation at their full original resolution. However, a decoded 3D video signal, which has been encoded using merged view 3D video compression, is presented for viewing at a reduced resolution compared with the resolution under which it was originally recorded. This can have a negative impact on the 3D TV viewing experience. Furthermore, merged view 3D video compression often discards information. Multiple compression generations may introduce noticeable artifacts which can also impair the 3D TV viewing experience.

### BRIEF DESCRIPTION OF THE DRAWINGS

Features of the present disclosure will become apparent to those skilled in the art from the following description with reference to the figures, in which:

FIG. 1 is a block diagram illustrating an encoding apparatus and a decoding apparatus, according to an example of the present disclosure;

FIG. 2 is an architecture diagram illustrating an example group of pictures (GOP) architecture operable with the encoding apparatus and the decoding apparatus shown in FIG. 1, according to an example of the present disclosure;

FIG. 3 is a system context block diagram illustrating the decoding apparatus shown in FIG. 1 in a backward compatible signal (BCS) architecture, according to an example of the present disclosure;

FIG. 4 is a flowchart illustrating an encoding method, according to an example of the present disclosure;

FIG. 5 is a flowchart illustrating a more detailed encoding method than the encoding method shown in FIG. 4, according to an example of the present disclosure;

FIG. 6 is a flowchart illustrating a decoding method, according to an example of the present disclosure;

FIG. 7 is a flowchart illustrating a more detailed decoding method than the decoding method shown in FIG. 6, according to an example of the present disclosure; and

FIG. 8 is a block diagram illustrating a computer system to provide a platform for the encoding apparatus and the decoding apparatus shown in FIG. 1, according to examples of the present disclosure.

### DETAILED DESCRIPTION

For simplicity and illustrative purposes, the present disclosure is described by referring mainly to examples thereof. In the following description, numerous specific details are set forth in order to provide a thorough understanding of the present disclosure. It is readily apparent however, that the present disclosure may be practiced without limitation to these specific details. In other instances, some methods and structures have not been described in detail so as not to unnecessarily obscure the present disclosure. Furthermore, different examples are described below. The examples may be used or performed together in different combinations. As used herein, the term “includes” means includes but not limited to the term “including”. The term “based on” means based at least in part on.

Many 3D video compression systems involve merged view formats using half resolution. Disclosed are methods, apparatuses and computer-readable mediums for encoding and decoding two views in three dimensional (3D) video compression such that full resolution is attained in a 3D display of the decoded stereoscopic video bitstream recorded at any definition level. The present disclosure demonstrates 3D video compression such that full resolution is attained for both views. The present disclosure also demonstrates a two dimensional (2D) backward compatible signal (BCS) from the 3D video compression. The 2D BCS may be at any resolution level, including full resolution and at any definition level. The 3D video compression may be at full resolution for both views and for any definition level used for the video signals. These definition levels include high definition (HD) such as used with HD digital television (HDTV) and super high definition (SHD) such as used with SHD digital television (SHDTV). The definition level utilized for the 3D video compression and 2D BCS is not limited and may be lower than standard-definition or higher than super high definition (SHD).

The term standard definition television (SDTV), as used herein, refers to a television system that has a video resolution that meets standards but is not considered to be either enhanced-definition television (EDTV) or high-definition television (HDTV). The term is used in reference to digital television, in particular when broadcasting at the same (or similar) resolution as analog systems. In the USA, SDTV refers to digital television broadcast in 4:3 aspect ratio with 720 (or 704) pixels horizontally and 480 pixels vertically.

The term high definition television (HDTV), as used herein, refers to video having resolution substantially higher than traditional television systems (standard-definition TV, or SDTV, or SD). HD has one or two million pixels per frame, roughly five times that of SD. HDTV is digitally broadcast using video compression. HDTV broadcast systems are identified with three major parameters: (1) Frame size in pixels is defined as number of horizontal pixels×number of vertical pixels, for example 1280×720 or 1920×1080. Often the number of horizontal pixels is implied from context and is omitted, as in the case of 720p and 1080p. (2) Scanning system is identified with the letter p for progressive scanning or i for interlaced scanning. (3) Frame rate is identified as number of video frames per second. If all three parameters are used, they are specified in the following form: [frame size][scanning system][frame or field rate] or [frame size]/[frame or field rate][scanning system]. Often, frame size or frame rate can be dropped if its value is implied from context. In this case the remaining numeric parameter is specified first, followed by the scanning system. For example, 1920×1080p24 identifies progressive scanning format with 24 frames per second, each frame being 1,920 pixels wide and 1,080 pixels high. The 1080i25 or 1080i50 notation identifies interlaced scanning format with 25 frames (50 fields) per second, each frame being 1,920 pixels wide and 1,080 pixels high. The 1080i30 or 1080i60 notation identifies interlaced scanning format with 30 frames (60 fields) per second, each frame being 1,920 pixels wide and 1,080 pixels high. The 720p60 notation identifies progressive scanning format with 60 frames per second, each frame being 720 pixels high; 1,280 pixels horizontally are implied.

The term super high definition television (SHDTV), as used herein, refers to video having resolution substantially higher than HDTV. SHDTV is also known as Ultra High Definition Television (UHDTV) (or Ultra HDTV or Ultra High Definition Video (UHDV)). A specification for SHDTV may be a resolution of 3840×2160 or higher, e.g. 7,680×4,320 pixels (approximately 33.2 megapixels) at an aspect ratio of (16:9) and a frame rate of 60 frame/s which may be progressive.

The term stereoscopic video signal, as used herein, refers to a video signal of a three dimensional (3D) recording, which may include a separate two dimensional (2D) view recording for each eye and any associated metadata.

The term progressive scanning, as used herein, also known non-interlaced scanning, refers to a way of capturing, displaying, storing or transmitting video images in which all the lines of each frame are captured or drawn in sequence. This is in contrast to interlacing where all the alternate lines, such as odd lines, then the even lines of each frame or image are captured or drawn alternately.

The term MPEG-4 AVC stream, as used herein, refers to a time series of bits into which audio and/or video is encoded in a format defined by the Motion Picture Experts Group for the MPEG-4 AVC standard. MPEG-4 AVC supports three frame/picture/slice/block types. These picture types are I, P and B. I is coded without reference to any other picture (or alternately slice). Only spatial prediction is applied to I. P and B may be temporally predictive coded. The temporal reference pictures can be any previously coded I, P and B. Both spatial and temporal predictions are applied to P and B. MPEG-4 AVC is a block-based coding method. A picture may be divided into macroblocks (MB). A MB can be coded in either intra mode or inter mode. MPEG-4 AVC offers many possible partition types per MB depending upon the picture type of I, P and B.

The term predictive coding information, as used herein, refers to coding information, such as motion vectors and transform coefficients describing prediction correction, obtained from related frames within a sequence or group of pictures in video compression. The predictive coding information obtained from a donor frame may be utilized in an inter frame coding process of an encoded receiving frame.

The term frame, as used herein, refers to a frame, picture, slice or block, such a macroblock or a flexible block partition in a video compression process. In the field of video compression a video frame is compressed using different machine readable instruction sets (i.e., algorithms) with different advantages and disadvantages, centered mainly around the level of data compression and compression noise. These different machine readable instruction sets (MRISs) for video frames are called picture types or frame types. The three major picture or frame types used in the different video MRISs are I, P and B. The three major picture/frame types are explained in more detail below. The term I-frame, as used herein, refers to a frame-type in video compression which is least compressible, and doesn't require predictive coding information from other types of video frames in order to be to decoded. An I-frame may also be referred to as an I-picture. One type of I-picture is an Instantaneous Decoder Refresh (IDR) I-picture. An IDR I-picture is an I-picture in which future pictures in a bit-stream do not use any picture prior to the IDR I-picture as a reference.

The term P-frame, as used herein, refers to a frame-type in video compression for predicted pictures and may use predictive coding information from previous or forward frames (in display or capture order) to decompress and are more compressible than I-frames.

The term B-frame, as used herein, refers to a frame-type in video compression which may use bi-predictive coding information from previous frames and forward frames in a sequence as referencing data in order to get the highest amount of data compression.

The term intra mode, as used herein, refers to a mode for encoding frames, such as I-frames, which may be coded without reference to any frames or pictures except themselves and generally require more bits to encode than other picture types.

The term inter mode, as used herein, refers to a mode for encoding predicted frames, such as B-frames and P-frames, which may be coded using predictive coding information from other frames and frame-types.

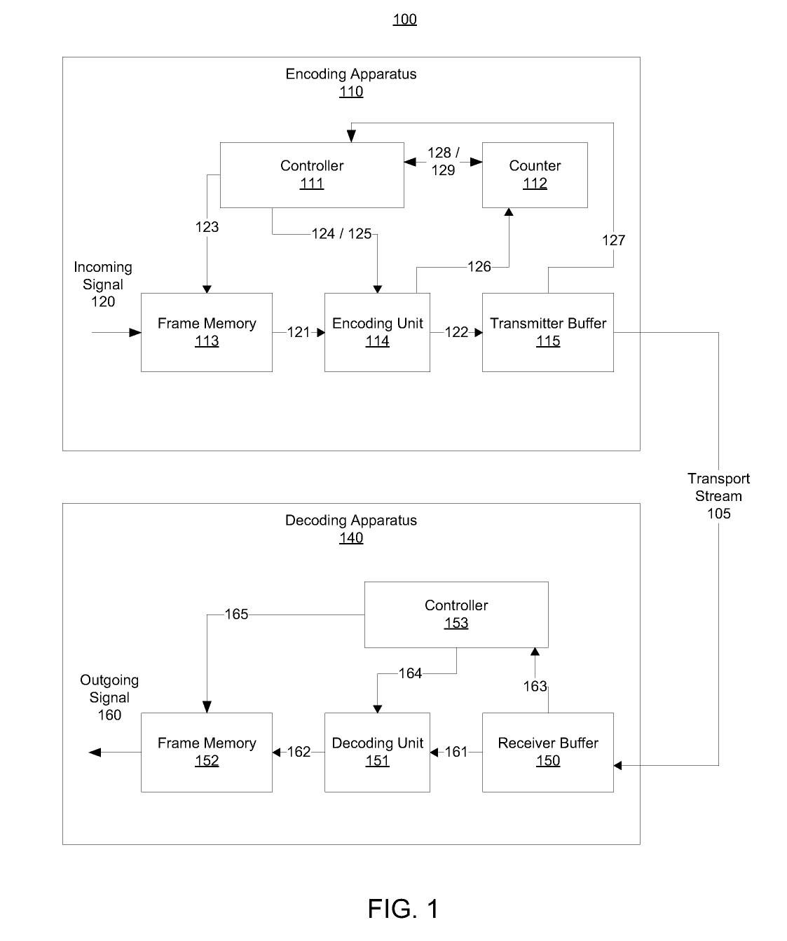

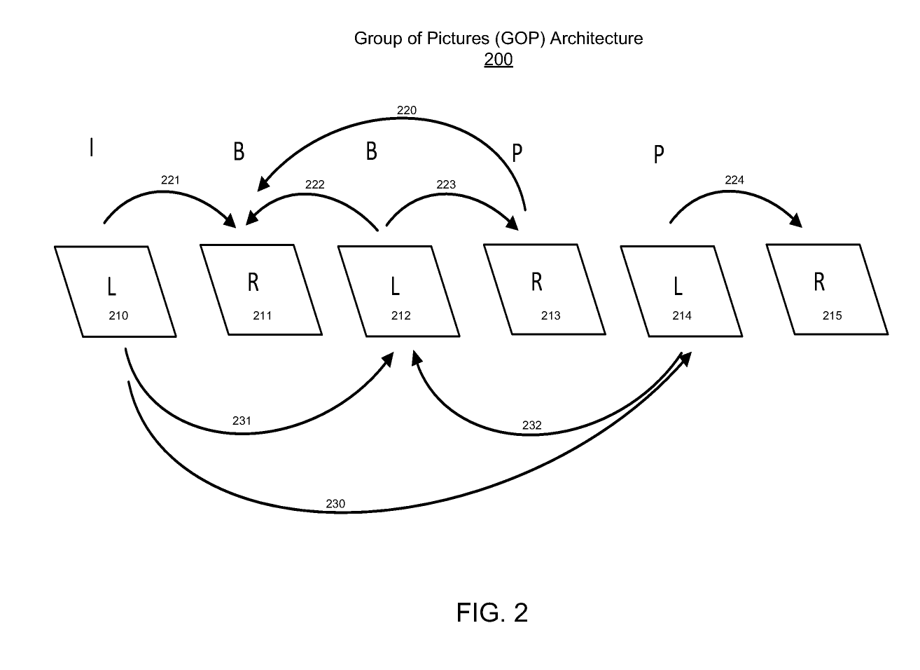

The present disclosure demonstrates encoding and decoding for 3D video compression such that full resolution is attained in a 3D display of the decoded stereoscopic video bitstream for video recorded at any definition level, including HD and SHD. Referring to FIG. 1, there is shown a simplified block diagram 100 of an encoding apparatus 110 and a decoding apparatus 140, for implementing an encoding of a group of pictures architecture 200 according to an example shown in FIG. 2. The encoding apparatus 110 and the decoding apparatus 140 are explained in greater detail below.

In the group of pictures architecture 200, according to the example, there are a plurality of frames, 210 to 215, which are interrelated in an encoded stereoscopic video stream according to spatial and/or temporal referencing. Frames 210, 212 and 214 are based on a first view associated with a left eye perspective. Frames 211, 213 and 215 are based on a second view associated with a right eye perspective.

In the example, the right eye perspective frames, such as frames 211, 213 and 215 do not include any I-frames based on the second view associated with the right eye perspective. Instead, right eye perspective frame utilize predictive coding information obtained right eye perspective frames as well as from left eye perspective frames. This is as illustrated by the predictive coding information transfers 220-224. In comparison, the left eye perspective frames include I-frames based on the first view associated with the left eye perspective, such the frame 210 I-frame. And the left eye perspective frames only utilize predictive coding information obtained from other left eye perspective frames as illustrated by the predictive coding information transfers 230-232.

The group of pictures architecture 200 illustrates how a full resolution display of both the right and left eye perspective may be accomplished without including any right-eye perspective I-frames in the encoded stereoscopic video bitstream recorded at any definition level. In addition, the right eye perspective frames may be discarded and the remaining left eye perspective frames provide a full resolution 2D video bitstream for video recorded at any definition level.

The group of pictures architecture 200 can be originally recorded at any definition level, such as at HD that is 720p60: which is a resolution of 1280×720 at 60 frames per second or 1080i30: which is a resolution of 1920×1080 at 30 interlaced frames per second provided for each eye. This may implemented in various ways. As an example, HDMI 1.4 television interfaces can already support the data rates necessary for HD resolution per eye. In addition, this may be implemented using 1080p60: which is 1920×1080 at 60 frames per second often used a 2D deployment. According to an example, two systems that may be utilized in the same time frame include a HD resolution 3D system and a 1080p60 2D TV systems. In addition full HD resolution 3D TV to be also be utilized with previously existing full HD 2D TV system and infrastructure. The group of pictures architecture 200 addresses both solutions. While many of the 3D TV systems considered for deployment use a half resolution of the originally recorded video resolution, the group of pictures architecture 200 enables systems which are a full HD resolution provided for each eye.

720p120 Per Eye Based 3D TV

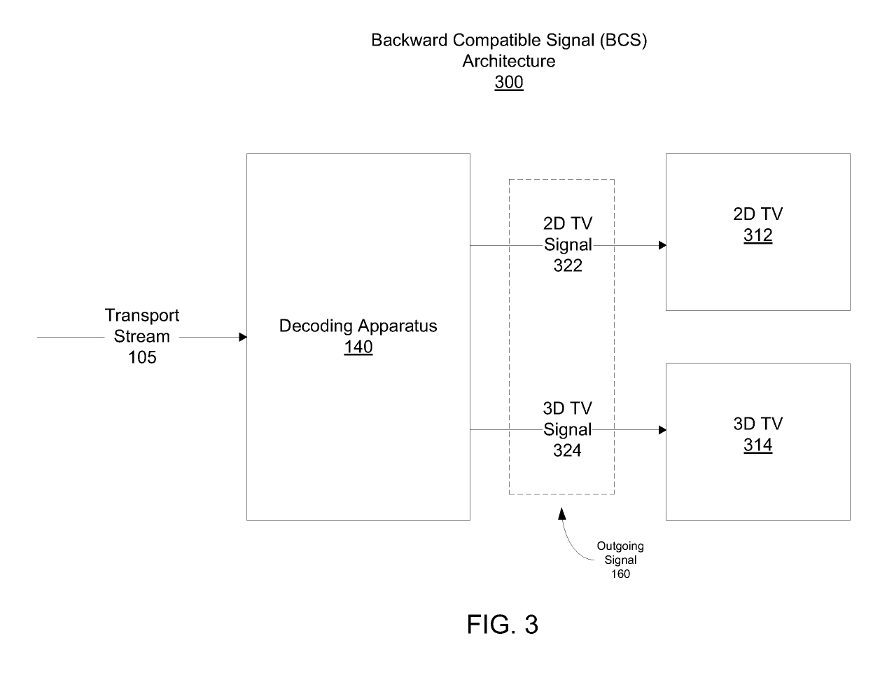

The group of pictures architecture 200 enables a 720p120 (720p60 per eye) based 3D TV system. According to this example, each eye view is captured at 1280×720×60p resolution. This corresponds to an existing infrastructure capability of 2D full HD systems for each eye. The left and right eye views may be time interleaved to create a 720p120 (1280×720 at 120 frames per sec) video stream. In the video stream of the example, odd numbered frames may correspond to a left eye view and even numbered frames correspond to a right eye view. The frames may be encoded such that the frames corresponding to one eye (e.g., the left eye) are compressed using the MPEG-4 AVC/H.264 standard in such a way that alternate left eye frames are skipped for temporal reference. In this example, odd number frames corresponding to the left eye view use only the odd number frames as references. Also in this example, even number frames, corresponding to the right eye view, may utilize use odd numbered frames and even numbered frames as references to provide predictive coding information. The frames corresponding to the left eye view do not use the frames corresponding to the right eye view as reference. For the right eye view, the use of intra mode encoding is not used. This provides coding efficiency and random accessing to the decoded video signal can be accomplished by starting at an I-frame for the left eye. Also, for backward compatibility with 2D HD systems, an IRD or set-top box Set Top can simply discard the even number frames corresponding to the right eye as demonstrated in greater detail below in FIG. 3.

From coding efficiency point of view, by avoiding the use of intra mode encoding for one eye perspective view in the encoded bitstream for the stereoscopic video signal, higher coding efficiency is accomplished. This is as compared with simulcasting the two eye views separately. This also enables use of a lower bit rate than the bit rate for one full 1080p60 2D channel because I-frames corresponding to only one eye may use smaller sized I-frames. Therefore, the encoded bitstream may be distributed using a 1080p60 2D network and infrastructure.

Also, the encoder used may signal in the bit-stream syntax that the left eye view is self contained. For example, in MPEG-4 AVC/H.264 syntax this may be accomplished, for example, by setting the left_view_self contained_flag equal to 1. When an Integrated Receiver Decoder (IRD) or a Set Top Box (STB) receives sees this signaling, the IRD or STB discards the alternate even frames to generate a 2D view (full HD 720p60) corresponding to the left eye view of the 3D content.

1080i30 Per Eye Based 3D TV

In this example, interlaced frames corresponding to the left and right eye may be time interleaved using the same process as described above for the 720p60 per eye system above.

1080p24 Per Eye Based 3D TV

In this example, a similar approach may be used by combining 1080p24 per eye video frames in the single video stream to generate a 1080p48 video stream with similar coding efficiency as that of Multiview Video Coding.

1080p60 Per Eye Based 3D TV

The compressed 720p120 encoded video bitstream described above may occupy less data space than a single 1080p60 network it runs through. The amount less depends on how efficient the cross eye prediction is, how large the encoded I-frames are, and how well the single 1080p60 encoded video signal compresses as compared to two 720p60 views. When there is a 30% savings, the 720p120 encoded 3D stream then occupies about 85% of the single 1080p60 encoded video signal, leaving at least a 15% extra capacity. In this circumstance, the horizontal resolution may be extended beyond 1280 pixels. A 1440 pixels horizontal resolution utilizes about 12.5% more bandwidth and in systems for displaying 1080p60 per eye based 3D TV, this extra resolution may be utilized in various ways, such as an by implementing metadata for an enhancement layer to improve user choices or viewing quality.

A further alternative would be to leave the 720p120 signal with its convenient compatibility to 720p60, and use the remaining capacity to send another enhancement layer for improving the quality. This would allow transmission of a 1080p60 encoded 2D TV bitstream over the single 1080p60 network which was otherwise utilized to carry the encoded 3D bitstream at 720p60 per eye.

FIG. 1 illustrates the encoding apparatus 110 and the decoding apparatus 140, according to an example. The encoding apparatus 110 delivers a transport stream 105, such as an MPEG-4 transport stream, to the decoding apparatus 140. The encoding apparatus 110 includes a controller 111, a counter 112, a frame memory 113, an encoding unit 114 and a transmitter buffer 115. The decoding apparatus 140 includes a receiver buffer 150, a decoding unit 151, a frame memory 152 and a controller 153. The encoding apparatus 110 and the decoding apparatus 140 are coupled to each other via a transmission path used to transmit the transport stream 105. The transport stream 105 is not limited to any specific video compression standard. The controller 111 of the encoding apparatus 110 controls the amount of data to be transmitted on the basis of the capacity of the receiver buffer 150 and may include other parameters such as the amount of data per a unit of time. The controller 111 controls the encoding unit 114, to prevent the occurrence of a failure of a received signal decoding operation of the decoding apparatus 140. The controller 111 may include, for example, a microcomputer having a processor, a random access memory and a read only memory.

An incoming signal 120 is supplied from, for example, a content provider. The incoming signal 120 includes stereoscopic video signal data. The stereoscopic video signal data may be passed into pictures and/or frames, which are input to the frame memory 113. The frame memory 113 has a first area used for storing the incoming signal 120 and a second area used for reading out the stored signal and outputting it to the encoding unit 114. The controller 111 outputs an area switching control signal 123 to the frame memory 113. The area switching control signal 123 indicates whether the first area or the second area is to be used.

The controller 111 outputs an encoding control signal 124 to the encoding unit 114. The encoding control signal 124 causes the encoding unit 114 to start the encoding operation. In response to the encoding control signal 124, the encoding unit 114 starts to read out the video signal to a high-efficiency encoding process to encode the pictures or frames to form encoded units, which form an encoded video bitstream. An encoded unit may be a frame, a picture, a slice, an MB, etc.

A coded video signal 122 with the coded units is stored in the transmitter buffer 115 and the information amount counter 112 is incremented to indicate the amount of data in the transmitted buffer 115. As data is retrieved and removed from the buffer, the counter 112 is decremented to reflect the amount of data in the buffer. The occupied area information signal 126 is transmitted to the counter 112 to indicate whether data from the encoding unit 114 has been added or removed from the transmitted buffer 115 so the counter 112 can be incremented or decremented. The controller 111 controls the production of coded units produced by the encoding unit 114 on the basis of the occupied area information 126 communicated in order to prevent an overflow or underflow from taking place in the transmitter buffer 115.

The information amount counter 112 is reset in response to a preset signal 128 generated and output by the controller 111. After the information counter 112 is reset, it counts data output by the encoding unit 114 and obtains the amount of information which has been generated. Then, the information amount counter 112 supplies the controller 111 with an information amount signal 129 representative of the obtained amount of information. The controller 111 controls the encoding unit 114 so that there is no overflow at the transmitter buffer 115.

The receiver buffer 150 of the decoding apparatus 140 may temporarily store the encoded data received from the encoding apparatus 110 via the transport stream 105. The decoding apparatus 140 counts the number of coded units of the received data, and outputs a picture or frame number signal 163 which is applied to the controller 153. The controller 153 supervises the counted number of frames at a predetermined interval, for instance, each time the decoding unit 151 completes the decoding operation.

When the picture/frame number signal 163 indicates the receiver buffer 150 is at a predetermined capacity, the controller 153 outputs a decoding start signal 164 to the decoding unit 151. When the frame number signal 163 indicates the receiver buffer 150 is at less than a predetermined capacity, the controller 153 waits for the occurrence of the situation in which the counted number of pictures/frames becomes equivalent to the predetermined amount. When the picture/frame number signal 163 indicates the receiver buffer 150 is at the predetermined capacity, the controller 153 outputs the decoding start signal 164. The encoded units may be decoded in a monotonic order (i.e., increasing or decreasing) based on a presentation time stamp (PTS) in a header of the encoded units.

In response to the decoding start signal 164, the decoding unit 151 decodes data amounting to one picture/frame from the receiver buffer 150, and outputs the data. The decoding unit 151 writes a decoded signal 162 into the frame memory 152. The frame memory 152 has a first area into which the decoded signal is written, and a second area used for reading out the decoded data and outputting it to a monitor or the like.

FIG. 3 illustrates the decoding apparatus 140 in a BCS architecture 300, according to an example. The decoding apparatus 140 receives the transport stream 105, such as an MPEG-4 transport stream, including an encoded stereoscopic video signal. In the encoded stereoscopic video signal, odd numbered frames may correspond to a left eye view and even numbered frames correspond to a right eye view.

The frames may be encoded such that the frames corresponding to one eye (e.g., the left eye) are compressed using the MPEG-4 AVC/H.264 standard in such a way that alternate left eye frames are skipped for temporal reference. In this example, odd number frames corresponding to the left eye view use only the odd number frames as references. Even number frames, corresponding to the right eye view, may utilize use odd numbered frames for referencing and even numbered frames as references to provide predictive coding information. The frames corresponding to the left eye view do not use the frames corresponding to the right eye view as reference. For the right eye view, the use of intra mode encoding is not used.

A decoded outgoing signal 160 from the decoding apparatus 140 includes a 3D TV signal 324 going to a 3D TV 324 and a 2D TV signal 322 going to a 2D TV 322. The 2D TV signal 322 is a BCS signal obtained through the decoding apparatus 140 discarding the right eye frames thus obtaining the 2D TV BCS of 2D TV signal 322 from the decoded data in the 3D TV signal 324 of outgoing signal 160.

Disclosed herein are methods and an apparatus for encoding a stereoscopic video signal and methods and an apparatus for decoding the encoded signal. With reference first to FIG. 1, there is shown a simplified block diagram of an encoding apparatus 110 and a decoding apparatus 140, according to an example. It is apparent to those of ordinary skill in the art that the diagram of FIG. 1 represents a generalized illustration and that other components may be added or existing components may be removed, modified or rearranged without departing from the scope of the encoding apparatus 110 and the decoding apparatus 140.

The encoding apparatus 110 is depicted as including, as subunits 111-115, a controller 111, a counter 112, a frame memory 113, an encoding unit 114 and a transmitter buffer 115. The controller 111 is to implement and/or execute the encoding apparatus 110. Thus, for instance, the encoding apparatus 110 may comprise a computing device and the controller 111 may comprise an integrated and/or add-on hardware device of the computing device. As another example, the encoding apparatus 110 may comprise a computer readable storage device (not shown) upon which is stored a computer programs, which the controller 111 is to execute.

As further shown in FIG. 1, the encoding unit 114 is to receive input from the frame memory 113. The encoding unit 114 may comprise, for instance, a user interface through which a user may access data, such as, left view frames and/or right view frames, objects, MRISs, applications, etc., that are stored in a data store (not shown). In addition, or alternatively, a user may interface the input interface 130 to supply data into and/or update previously stored data in the data store 118. The transmitter buffer 115 may also comprise a user interface through which a user may access a version of the data stored in the data store, as outputted through the transmitter buffer 115.

According to an example, the encoding apparatus 110 is to process the incoming video signal 120 stored in the frame memory 113. The left view frames and/or right view frames are in the incoming video signal 120 stored in the frame memory 113. According to an example, the frame memory 113 may comprise non-volatile byte-addressable memory, such as, battery-backed random access memory (RAM), phase change RAM (PCRAM), Memristor, and the like. In addition, or alternatively, the frame memory 113 may comprise a device to read from and write to external removable media, such as a removable PCRAM device. Although the frame memory 113 has been depicted as being internal or attached to the encoding apparatus 110, it should be understood that the frame memory 113 may be remotely located from the encoding apparatus 110. In this example, the encoding apparatus 110 may access the frame memory 113 through a network connection, the Internet, etc.

As further shown in FIG. 1, the decoding apparatus 140 includes, as subunits, a receiver buffer 150, a decoding unit 151, a frame memory 152 and a controller 153. The subunits 150-153 may comprise MRIS code modules, hardware modules, or a combination of MRISs and hardware modules. Thus, in one example, the subunits 150-153 may comprise circuit components. In another example, the subunits 150-153 may comprise code stored on a computer readable storage medium, which the controller 153 is to execute. As such, in one example, the decoding apparatus 140 comprises a hardware device, such as, a computer, a server, a circuit, etc. In another example, the decoding apparatus 140 comprises a computer readable storage medium upon which MRIS code for performing the functions of the subunits 150-153 is stored. The various functions that the decoding apparatus 140 performs are discussed in greater detail below.

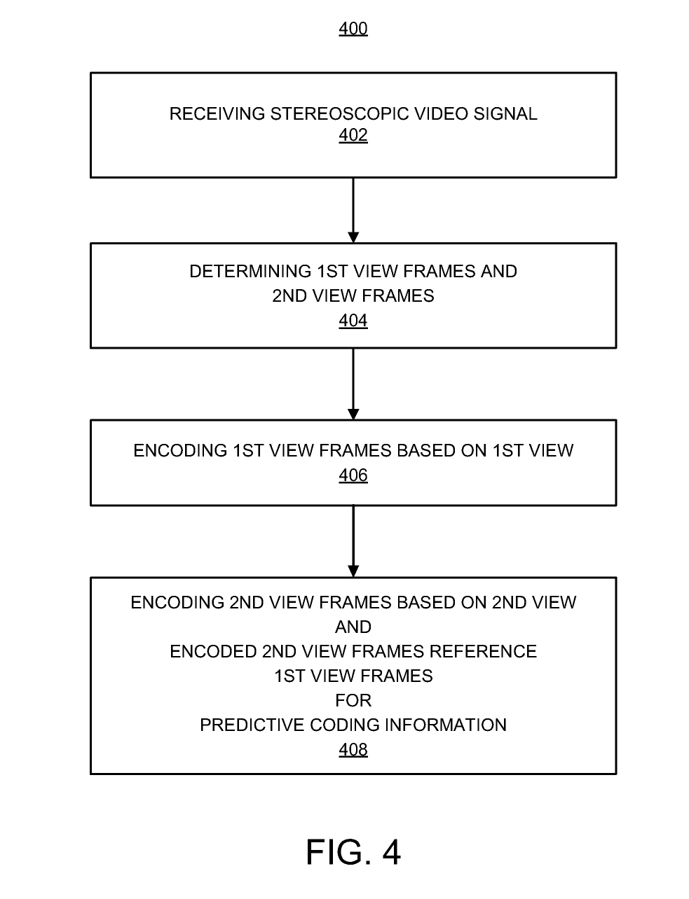

According to an example, the encoding apparatus 110 and/or the decoding apparatus 140 are to implement methods of encoding and decoding. Various manners in which the subunits 111-115 of the encoding apparatus and/or the subunits 150-153 of the decoding apparatus 140 may be implemented are described in greater detail with respect to FIGS. 4 to 7, which depict flow diagrams of methods 400 and 500 to perform encoding and of methods 600 and 700 to perform decoding according to blocks in the flow diagrams. It is apparent to those of ordinary skill in the art that the encoding and decoding methods 400 to 700 represent generalized illustrations and that other blocks may be added or existing blocks may be removed, modified or rearranged without departing from the scopes of the encoding and decoding methods 400 to 700.

The descriptions of the encoding methods 400 and 500 are made with particular reference to the encoding apparatus 110 depicted in FIG. 1 and the group of pictures architecture diagram 200 depicted in FIG. 2. It should, however, be understood that the encoding methods 400 and 500 may be implemented in an apparatus that differs from the encoding apparatus 110 and the group of pictures architecture 200 without departing from the scopes of the methods 400 and 500.

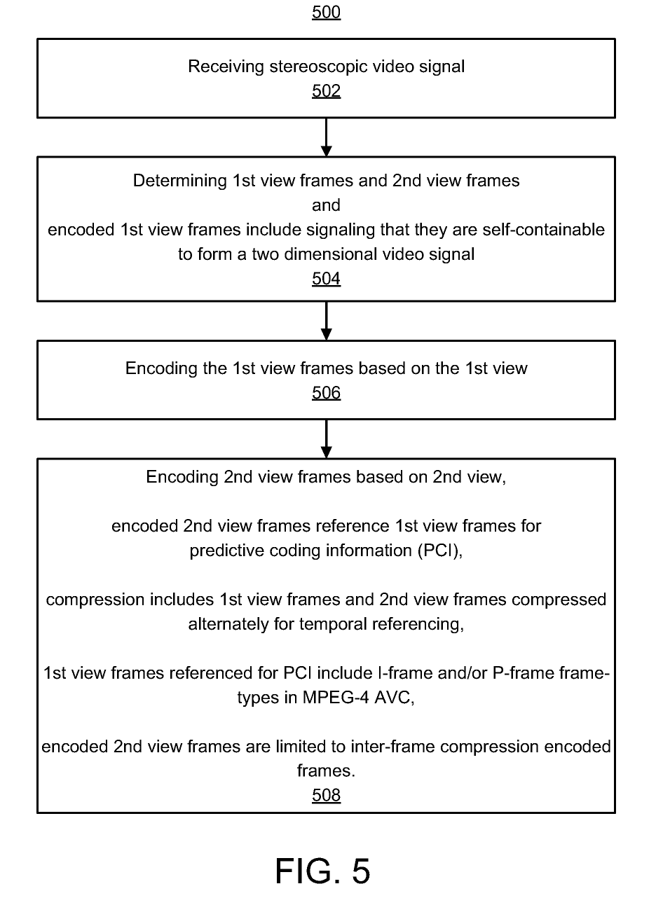

With reference first to the method 400 in FIG. 4, at block 402, receiving the stereoscopic video signal as the incoming signal 120 is performed utilizing the frame memory 113. In one example, the incoming signal 120 includes first view frames based on a first view associated with a first eye perspective and second view frames based on a second view associated with a second eye perspective. With reference to the method 500 in FIG. 5, at block 502, receiving the stereoscopic video signal as the incoming signal 120 is also performed utilizing the frame memory 113.

Block 404 may be implemented utilizing the frame memory 113 and/or the encoding unit 114, optionally with the controller 111 in response to the incoming signal 120 including first view frames based on a first view associated with a first eye perspective and second view frames based on a second view associated with a second eye perspective which are received in the frame memory 113 associated with block 402.

With reference first to the method 400 in FIG. 4, determining the first view frames and the second view frames is performed utilizing the frame memory 113. In one example, the first view frames are removed from the frame memory 113 in a separate batch and output to the encoding unit 114. With reference to the method 500 in FIG. 5, at block 504, determining the first view frames and the second view frames is performed utilizing the frame memory 113 and/or the encoding unit 114, optionally with the controller 111. According to this example, the first and second view frames are output together from the frame memory 113 to the encoding unit 114 and separated into left and right view frames as identified with respect to the group of pictures architecture 200. Also in block 504, encoding the first view frames comprises encoding the first view frames with a signal to indicate they are self-containable to form a two-dimensional video signal.

Block 406, in FIG. 4, may be implemented after the first view frames are received in the encoding unit 114. In block 406 the first view frames are encoded based on the first view. Block 506, in FIG. 5, may also be implemented after the first view frames are received in the encoding unit 114. In block 506 the first view frames are encoded based on the first view. Both blocks 406 and 506 may be implemented utilizing the encoding unit 114.

Block 408, in FIG. 4, may be implemented after second view frames and the first view frames are both received in the encoding unit 114. Block 508, in FIG. 5, may also be implemented after second view frames and the first view frames are both received in the encoding unit 114. Blocks 408 and 508 include encoding the second view frames based on the second view as well as utilizing predictive coding information derived by referencing the first view frames. Also in block 508, encoding the second view frames comprises forming a compressed video bitstream such that the compression includes the first view frames and the second view frames compressed alternately for temporal referencing, the first view frames referenced for predictive coding information may include at least one of I-frame and P-frame frame-types in MPEG-4 AVC, and the encoded second view frames are limited to inter-frame compression encoded frames. Both blocks 408 and 508 may be implemented utilizing the encoding unit 114.

The descriptions of the decoding methods 600 and 700 are made with particular reference to the decoding apparatus 140 depicted in FIG. 1 and the group of pictures architecture diagram 200 depicted in FIG. 2. It should, however, be understood that the decoding methods 600 and 700 may be implemented in an apparatus that differs from the decoding apparatus 140 and the group of pictures architecture 200 without departing from the scopes of the decoding methods 600 and 700.

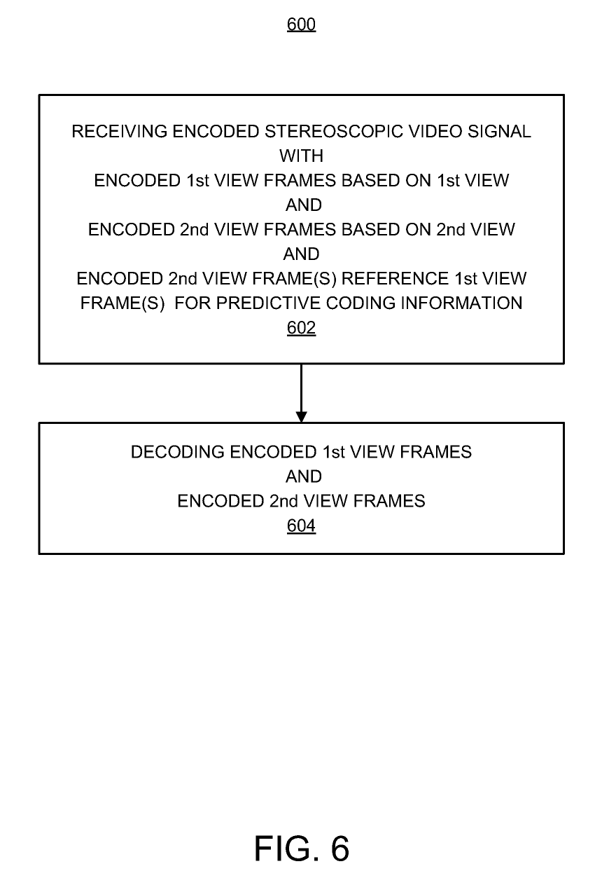

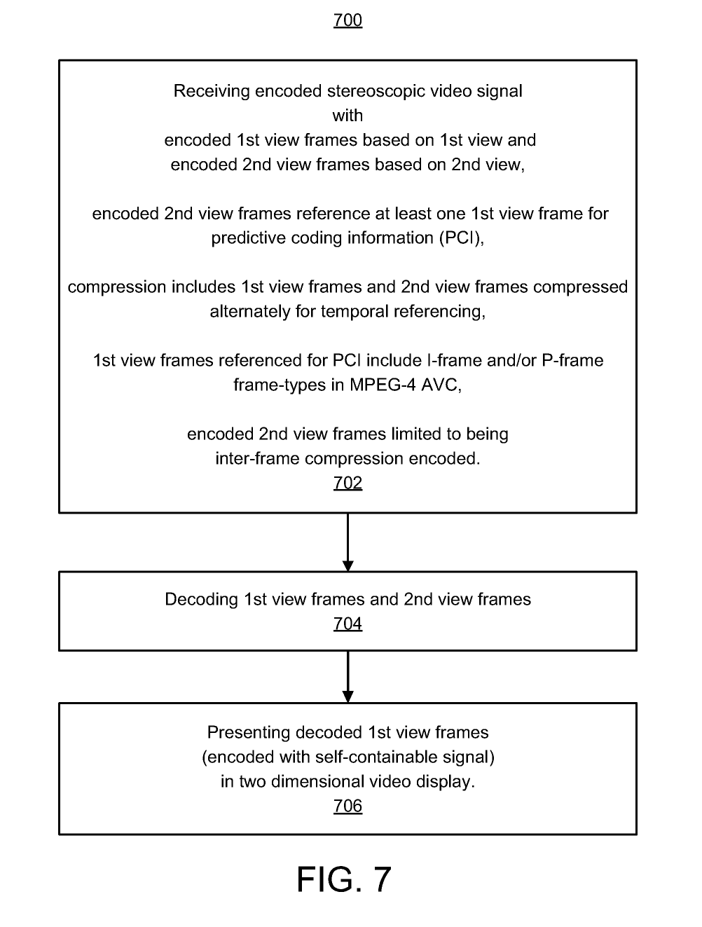

With reference first to the method 600 in FIG. 6, at block 602, receiving the encoded stereoscopic video signal in the transport stream 105 is performed utilizing the receiver buffer 150. In one example, the transport stream 105 includes encoded first view frames based on a first view associated with a first eye perspective and encoded second view frames based on a second view associated with a second eye perspective. With reference to the decoding method 700 in FIG. 7, at block 702, receiving the stereoscopic video signal in the transport stream 105 is also performed utilizing the receiver buffer 150. In blocks 602 and 702, the encoded second view frames reference at least one first view frame for predictive coding information. Also in block 702, the compression includes the first view frames and the second view frames compressed alternately for temporal referencing, the first view frames referenced for predictive coding information include at least one of I-frame and P-frame frame-types in MPEG-4 AVC, and the encoded second view frames are limited to inter-frame compression encoded frames.

Block 604 may be implemented utilizing the receiver buffer 150 and the decoding unit 151, optionally with the controller 153 in decoding the first view frames and the second view frames. Block 704 may also be implemented utilizing the receiver buffer 150 and the decoding unit 151, optionally with the controller 153 in decoding the first view frames and the second view frames.

Block 706 is optional and may be implemented utilizing the receiver buffer 150 and the decoding unit 151, optionally with the controller 153, to present only the decoded first eye view for two dimensional video display.

Some or all of the operations set forth in the figures may be contained as a utility, program, or subprogram, in any desired computer readable storage medium. In addition, the operations may be embodied by computer programs, which can exist in a variety of forms both active and inactive. For example, they may exist as MRIS program(s) comprised of program instructions in source code, object code, executable code or other formats. Any of the above may be embodied on a computer readable storage medium, which include storage devices.

An example of a computer readable storage media includes a conventional computer system RAM, ROM, EPROM, EEPROM, and magnetic or optical disks or tapes. Concrete examples of the foregoing include distribution of the programs on a CD ROM or via Internet download. It is therefore to be understood that any electronic device capable of executing the above-described functions may perform those functions enumerated above.

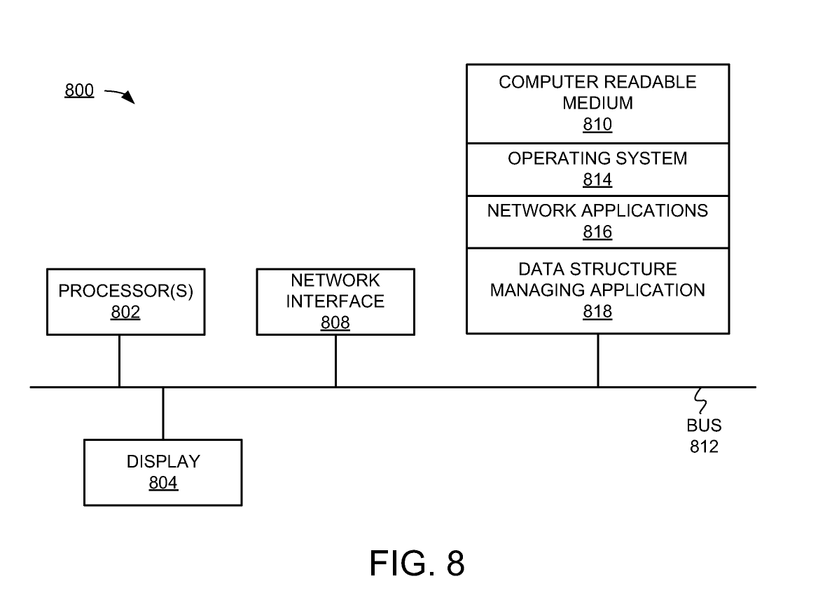

Turning now to FIG. 8, there is shown a computing device 800, which may be employed as a platform for implementing or executing the methods depicted in FIGS. 4 to 7, or code associated with the methods. It is understood that the illustration of the computing device 800 is a generalized illustration and that the computing device 800 may include additional components and that some of the components described may be removed and/or modified without departing from a scope of the computing device 800.

The device 800 includes a processor 802, such as a central processing unit; a display device 804, such as a monitor; a network interface 808, such as a Local Area Network (LAN), a wireless 802.11x LAN, a 3G or 4G mobile WAN or a WiMax WAN; and a computer-readable medium 810. Each of these components may be operatively coupled to a bus 812. For example, the bus 812 may be an EISA, a PCI, a USB, a FireWire, a NuBus, or a PDS.

The computer readable medium 810 may be any suitable medium that participates in providing instructions to the processor 802 for execution. For example, the computer readable medium 810 may be non-volatile media, such as an optical or a magnetic disk; volatile media, such as memory; and transmission media, such as coaxial cables, copper wire, and fiber optics. Transmission media can also take the form of acoustic, light, or radio frequency waves. The computer readable medium 810 may also store other MRIS applications, including word processors, browsers, email, instant messaging, media players, and telephony MRIS.

The computer-readable medium 810 may also store an operating system 814, such as MAC OS, MS WINDOWS, UNIX, or LINUX; network applications 816; and a data structure managing application 818. The operating system 814 may be multi-user, multiprocessing, multitasking, multithreading, real-time and the like. The operating system 814 may also perform basic tasks such as recognizing input from input devices, such as a keyboard or a keypad; sending output to the display 804 and the design tool 806; keeping track of files and directories on medium 810; controlling peripheral devices, such as disk drives, printers, image capture device; and managing traffic on the bus 812. The network applications 816 includes various components for establishing and maintaining network connections, such as MRIS for implementing communication protocols including TCP/IP, HTTP, Ethernet, USB, and FireWire.

The data structure managing application 818 provides various MRIS components for building/updating a CRS architecture, such as CRS architecture 800, for a non-volatile memory, as described above. In certain examples, some or all of the processes performed by the application 818 may be integrated into the operating system 814. In certain examples, the processes may be at least partially implemented in digital electronic circuitry, in computer hardware, firmware, MRIS, or in any combination thereof.

Disclosed herein are methods, apparatuses and computer-readable mediums for encoding and decoding two views in three dimensional (3D) video compression such that full resolution is attained in a 3D display of the decoded stereoscopic video bitstream recorded at any definition level. The instant disclosure demonstrates 3D video compression such that full resolution is attained for both views at higher coding efficiency. The present disclosure also demonstrates a two dimensional (2D) backward compatible signal (BCS) from the 3D video compression. The 2D BCS may be at any resolution level, including full resolution and at any definition level. The 3D video compression may be at full resolution for both views and for any definition level used for the video signals. These definition levels include high definition (HD) such as used with HD digital television (HDTV) and super high definition (SHD) such as used with SHD digital television (SHDTV). The definition level utilized for the 3D video compression and 2D BCS is not limited and may be lower than standard-definition or higher than super high definition (SHD).

Although described specifically throughout the entirety of the instant disclosure, representative examples have utility over a wide range of applications, and the above discussion is not intended and should not be construed to be limiting. The terms, descriptions and figures used herein are set forth by way of illustration only and are not meant as limitations. Those skilled in the art recognize that many variations are possible within the spirit and scope of the examples. While the examples have been described with reference to examples, those skilled in the art are able to make various modifications to the described examples without departing from the scope of the examples as described in the following claims, and their equivalents.

What is claimed is:

1. A method for encoding a stereoscopic video signal including first view frames based on a first view associated with a first eye perspective and second view frames based on a second view associated with a second eye perspective, the encoding method comprising:
receiving the stereoscopic video signal;
determining, using a processor, the first view frames and the second view frames;
encoding the first view frames based on the first view; and
encoding the second view frames based on the second view and also the first view, wherein a plurality of the encoded second view frames reference at least one first view frame for predictive coding information.

2. The encoding method of claim 1, wherein the first view frames and the second view frames are in a progressive scanning format having a vertical frame size of 720 pixels and a horizontal frame size of 1,280 for presentation at a frame rate of 60 video frames per second.

3. The encoding method of claim 1, wherein the first view frames and the second view frames have a vertical frame size of 1440 pixels and a horizontal frame size of 1,080 pixels.

4. The encoding method of claim 1, wherein an extra bandwidth within a communications network infrastructure associated with the encoding of the second view frames based on the second view and also the first view is utilized to enhance a 2D backward compatible signal sent via the communications network infrastructure.

5. The encoding method of claim 1, wherein the encoded first view frames and the encoded second view frames are encoded for transmission within a communications network infrastructure having a capacity for transmitting a two dimensional video signal having frames in a progressive scanning format having a vertical frame size of 1,080 pixels and a horizontal frame size of 1,920 for presentation in a two dimensional video display at a frame rate of 60 video frames per second.

6. The encoding method of claim 1, wherein the encoded second view frames are compressed with the encoded first view frames and the compression includes the first view frames and the second view frames compressed alternately for temporal referencing.

7. The encoding method of claim 1, wherein the first view frames referenced for predictive coding information include at least one of I-frame and P-frame frame-types according to MPEG-4 AVC.

8. The encoding method of claim 1, wherein the encoded second view frames exclude intra-frame compression encoded frames based on the second view.

9. The encoding method of claim 8, wherein the encoded second view frames exclude I-frame frame-types according to MPEG-4 AVC.

10. The encoding method of claim 1, wherein the encoded second view frames are limited to inter-frame compression encoded frames.

11. The encoding method of claim 10, wherein the encoded second view frames are limited to B-frame and P-frame frame-types according to MPEG-4 AVC.

12. The encoding method of claim 1, wherein the encoded first view frames include signaling that the first view frames are self-containable to form a two dimensional video signal.

13. A non-transitory computer readable medium storing computer readable instructions that when executed by a computer system perform a method for encoding a stereoscopic video signal including first view frames based on a first view associated with a first eye perspective and second view frames based on a second view associated with a second eye perspective, the encoding method comprising:
receiving the stereoscopic video signal;
determining, using a processor, the first view frames and the second view frames;
encoding the first view frames based on the first view; and
encoding the second view frames based on the second view and also the first view, wherein a plurality of the encoded second view frames reference at least one first view frame for predictive coding information.

14. An encoding apparatus to encode a stereoscopic video signal including first view frames based on a first view associated with a first eye perspective and second view frames based on a second view associated with a second eye perspective, the encoding apparatus comprising:
a processor to
receive the stereoscopic video signal;
determine the first view frames and the second view frames;
encode the first view frames based on the first view; and
encode the second view frames based on the second view and also the first view, wherein a plurality of the encoded second view frames reference at least one first view frame for predictive coding information.

15. A method for decoding an encoded stereoscopic video signal including encoded first view frames based on a first view associated with a first eye perspective and encoded second view frames based on a second view associated with a second eye perspective, the decoding method comprising:
receiving the encoded stereoscopic video signal including encoded first view frames encoded based on the first view and encoded second view frames encoded based on the second view and also the first view, wherein a plurality of the encoded second view frames reference at least one first view frame for predictive coding information; and
decoding the first view frames and the second view frames.

16. The decoding method of claim 15, wherein the first view frames and the second view frames are in a progressive scanning format having a vertical frame size of 720 pixels and a horizontal frame size of 1,280 for presentation at a frame rate of 60 video frames per second.

17. The decoding method of claim 15, wherein the first view frames and the second view frames have a vertical frame size of 1440 pixels and a horizontal frame size of 1,080 pixels.

18. The decoding method of claim 15, wherein an extra bandwidth within a communications network infrastructure associated with the encoding of the second view frames based on the second view and also the first view is utilized to enhance a 2D backward compatible signal sent via the communications network infrastructure.

19. The decoding method of claim 15, wherein the encoded first view frames and the encoded second view frames are encoded for transmission within a communications network infrastructure having a capacity for transmitting a two dimensional video signal having frames in a progressive scanning format having a vertical frame size of 1,080 pixels and a horizontal frame size of 1,920 for presentation in a two dimensional video display at a frame rate of 60 video frames per second.

20. The decoding method of claim 15, wherein the encoded second view frames are compressed with the encoded first view frames and the compression includes the first view frames and the second view frames compressed alternately for temporal referencing.

21. The decoding method of claim 15, wherein the first view frames referenced for predictive coding information include at least one of I-frame and P-frame frame-types according to MPEG-4 AVC.

22. The decoding method of claim 15, wherein the encoded second view frames exclude intra-frame compression encoded frames based on the second view.

23. The decoding method of claim 22, wherein the encoded second view frames exclude I-frame frame-types according to MPEG-4 AVC.

24. The decoding method of claim 15, wherein the encoded second view frames are limited to inter-frame compression encoded frames.

25. The decoding method of claim 24, wherein the encoded second view frames are limited to B-frame and P-frame frame-types according to MPEG-4 AVC.

26. The decoding method of claim 15, wherein the encoded first view frames include signaling that the first view frames are self-containable to form a two dimensional video signal.

27. A non-transitory computer readable medium storing computer readable instructions that when executed by a computer system perform a method for decoding an encoded stereoscopic video signal including encoded first view frames based on a first view associated with a first eye perspective and encoded second view frames based on a second view associated with a second eye perspective, the decoding method comprising:
receiving the encoded stereoscopic video signal including encoded first view frames encoded based on the first view and encoded second view frames encoded based on the second view and also the first view, wherein a plurality of the encoded second view frames reference at least one first view frame for predictive coding information; and
decoding the first view frames and the second view frames.

28. A decoding apparatus to decode an encoded stereoscopic video signal including encoded first view frames based on a first view associated with a first eye perspective and encoded second view frames based on a second view associated with a second eye perspective, the decoding apparatus comprising:
a processor to
receive the encoded stereoscopic video signal including encoded first view frames encoded based on the first view and encoded second view frames encoded based on the second view and also the first view, wherein a plurality of the encoded second view frames reference at least one first view frame for predictive coding information; and
decode the first view frames and the second view frames.
